(19) United States
(12) Patent Application Publication
(10) Pub. No.: US 2009/0213529 A1
(43) Pub. Date: Aug. 27, 2009

(54) Nanocellular high surface area material and methods for use and production thereof

(75) Inventors: Yury Gogotsi, Ivyland, PA (US); John Chmiola, Plains, PA (US); Gleb Yushin, Atlanta, GA (US); Rajan Dash, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 11/911,248

(22) PCT Filed: Apr. 14, 2006
(86) PCT No.: PCT/US06/14048

§ 371 Date: Jun. 10, 2008

Related U.S. Application Data
(60) Provisional application No. 60/671,290, filed on Apr. 14, 2005.

(51) Int. Cl. H01G 9/155; B32B 3/26; C01B 31/02

(52) U.S. Cl. 361/502; 428/315.5; 423/445 R

(57) ABSTRACT

Nanocellular high surface area materials of a carbon material with high surface area that is controllable and which exhibits high conductivity, controllable structure and a precisely controllable pore size and methods for production and use of these materials are provided.

This patent application claims the benefit of priority from U.S. Provisional Application Ser. No. 60/671,290, filed Apr. 14, 2005, teachings of which are herein incorporated by reference in their entirety.

### FIELD OF THE INVENTION

The present invention relates a nanocellular carbon material and a method for its production via removal of metal from metal carbides at elevated temperatures in a halogen environment. Carbon material of the present invention produced in accordance with this production method has a surface area, pore size and microstructure that can be precisely fine tuned and optimized to provide superior performance when used in a given application. The nanocellular carbon material of the present invention is particularly useful in electrochemical storage applications.

### BACKGROUND OF THE INVENTION

Research interest in highly porous carbons has increased in recent years for a number of different applications such as methane and hydrogen storage, adsorbents, catalyst supports, as well as electrochemical double layer capacitors (EDLCs) (Conway, B. E. Electrochemical Capacitors; Scientific Fundamentals and Technological Applications, Kluwer, (1999)). EDLCs use a non-Faradaic charge separation across the electrolyte/electrode interface to store electrical energy. In general, an EDLC behaves like a traditional parallel plate capacitor, whereby the capacitance is roughly proportional to the surface area of the plates. The dependence of capacitance on specific surface area (SSA) is not linear, however. Micropores (pores with diameters less than 2 nm) contribute to most of the SSA, but the smallest ones may not be accessible to the electrolyte. It is therefore important to design a carbon electrode which has pores that are large enough to be completely accessed by the electrolyte, but small enough to result in a large surface area per unit volume. In general, pore sizes of roughly twice the solvated ion size should be sufficient to contribute to double-layer capacitance (Endo et al. J. Electrochem. Soc. 2001 148(8):A910). For an aqueous electrolyte, pores as small as 0.5 nm should be accessible. For solvated ions in aprotic media, larger pores are needed (Beguin, F. Carbon 2001 39(6):937). Consequently, it is important to tailor the pore size distribution in the electrode material to match that needed to maximize the specific capacitance.

Various carbonaceous materials have been studied as electrode materials for EDLCs, such as activated organic materials (Guo et al. Mater. Chem. Phys. 2003 80(3):704), carbonized polymers (Endo et al. Electrochem Solid St 2003 6(2):A23; Kim et al. J. Electrochem. Soc 2004 151(6):E199), aerogels (Saliger et al. Journal of Non-Crystalline Solids 1998 225(1):81), carbon fibers (Nakagawa et al. J. Electrochem. Soc. 2000 147(1):38) and nanotubes (Frackowiaket al. J. Power Sources 2001 97-98:822; An et al. J. Electrochem. Soc. 2002 149(8):A1058; Pico et al. J. Electrochem. Soc. 2004 151(6):A831; Zhou et al. J. Electrochem. Soc. 2004 151(7):A1052). These have different pore structures and surface chemistries due to the different processing techniques and starting materials. Kim et. al showed specific capacitances of 100 Farad/gram of material (F/g) for carbonized polymer in an aqueous electrolyte, but only 5 F/g in an organic electrolyte with larger ions (J. Electrochem. Soc. 2004 151(6):E199). The use of templating agents to produce carbons with controlled pore size distribution results in specific capacitances as high as 200 F/g when organic electrolytes are used (Yoon et al. J. Electrochem Soc. 2000 147(7):2501; Hisashi et al. Electrochem. Solid St. 2003 122(2):219; Zhou et al. J. Power Sources 2003 122 (2):219). This technique is limited to producing mesopores (pores with a diameter greater than 2 nm), and is not suited to scale-up due to lengthy processing. At 180 F/g, modified single-wall nanotubes exhibit large specific capacitance, but their cost is prohibitive. Multi-wall carbon nanotubes, because of low specific surface area, traditionally have low specific capacitance. Etching or other post treatments have increased the performance of these materials significantly, but not enough to overcome their prohibitive cost.

Recently, a new group of porous carbon materials, carbide derived carbons (CDCs), have been receiving attention in literature for applications in EDLCs (U.S. Pat. No. 6,110,335; Burke, A. J. Power Sources 2000 9(1):37; WO 02/39468; Lust et al. J. Electroanal. Chem. 2003 562(1):33). CDCs are obtained by selective leaching of metals from metal carbides with halogens (Nikitin, A. and Gogotsi, Y, Nanostructured Carbide Derived Carbon (CDC), Encyclopedia of Nanoscience and Nanotechnology, H. S. Nalwa, American Scientific Publishers 7 553 (2003)). The resulting carbon has high SSA, with pore sizes that can be fine-tuned by controlling the chlorination temperature and by the choice of starting carbide (Gogotsi et al. Nat. Mater. 2003 2(9):591). Previous work showed high SSA with a narrow pore size distributions (Dash et al. Microporous and Mesoporous Materials 2004 72:203), suggesting high specific capacitances.

### SUMMARY OF THE INVENTION

An object of the present invention is to provide a nanocellular high surface area material which comprises a carbon material with high surface area that is controllable and which exhibits high conductivity, controllable structure and a precisely controllable pore size, all of which are optimized by selecting synthesis conditions.

Another object of the present invention is to provide a method for producing a nanocellular high surface area material which comprises removing non-carbon atoms from an inorganic carbon-containing precursor via thermo-chemical, chemical or thermal treatment of the inorganic carbon-containing precursor in a temperature range of 200-1200° C. In a preferred embodiment, the inorganic carbon-containing precursor is a metal carbide and non-carbon atoms are removed at elevated temperatures in a halogen environment to produce a carbon material with a high surface area that is controllable and which exhibits high conductivity, a controllable structure and a precisely controllable pore size.

### BRIEF DESCRIPTION OF THE FIGURES

FIGS. 1(a) and 1(b) are representative TEM images of Ti₂AlC CDCs synthesized at temperatures of 600° C. (FIG. 1 (a)) and 1200° C. (FIG. 1 (b)). Structure of CDC samples depends on the synthesis temperature and choice of starting carbide material. Samples prepared at low temperature are amorphous. Those prepared at higher temperature contain graphite ribbons.

FIGS. 2(a) and 2(b) are graphs of BET SSA and specific capacitance versus chlorination temperature for Ti₂AlC CDC (FIG. 2(a)), and B₄C CDC (FIG. 2(b)). The linear correlation between these parameters for Ti₂AlC CDCs suggests that most of the CDC pores are accessible to the electrolyte ions, irrespective of the synthesis temperature. The small deviations from the linear dependence of the specific capacitance and the SSA seen in B₄C CDCs may be due to the incomplete accessibility of the smallest pores to the electrolyte.

FIGS. 3(a), 3(b), 3(c) and 3(d) show average pore diameters calculated using Ar as the adsorbate, density functional theory and a weighted method which takes into account contributions of pore volume (FIG. 3 (a)); pore size distribution for activated carbon (FIG. 3 (b)) and B₄C CDC synthesized at 600° C. (FIG. 3(c)) and 1200° C. (FIG. 3 (d)).

FIGS. 4(a) and 4(b) are Current-Voltage curves (also referred to as I-V diagrams) obtained from cyclic voltammetry tests run at a scan rate of 1 mV/second on B₄C CDCs (FIG. 4(a)) and Ti₂AlC CDCs (FIG. 4(b)).

FIGS. 5(a), 5(b), 5(c) and 5(d) are I-V curves taken at scan rates of 50 mV/s (FIG. 5(a)), 25 mV/s ((FIG. 5(b)), 10 mV/s (FIG. 5(c)) and 5 mV/s (FIG. 5(d)) for activated carbon (1), multi-wall carbon nanotubes (2), B₄C CDC synthesized at 1000° C. (3) and Ti₂AlC CDC synthesized at 1000° C. (4). Activated carbon with the smallest pores showed the slowest current response at high scan rates.

FIG. 6 is line graph showing the improved capacitance in H₂SO₄ of ZrC CDC synthesized in the 800° C. to 1200° C. range before and after hydrogen annealing for 2 hours at 600° C. Specific capacitance of nanocellular carbon synthesized from ZrC before and after hydrogen (H₂) annealing. Annealing in hydrogen at 600° C. for 2 hours clearly increased specific capacitance values.

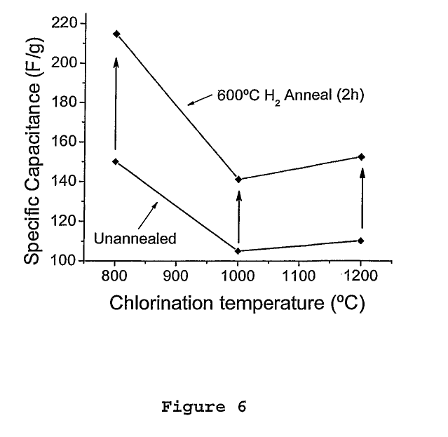

FIGS. 7(a), 7(b), 7(c) and 7(d) show the improved time constant and improved specific capacitance for capacitors constructed from nanoparticle carbide precursors. Effect of precursor particle size on specific capacitance and frequency response of nanocellular carbon (derived from SiC at 800 (7(a)) and 1000° C. 7(b))). The size of SiC nanoparticles was approximately 30 nm; the size of SiC particles (used for the comparison and termed “micron powder”) was approximately 0.8 micron. Decreasing the size of carbide precursor resulted in the increase of specific capacitance as well as in the improvement of frequency response (7(c)). When nanocellular carbon was synthesized at 800° C., characteristic time constant decreased from 125 to 60 seconds (7(d)).

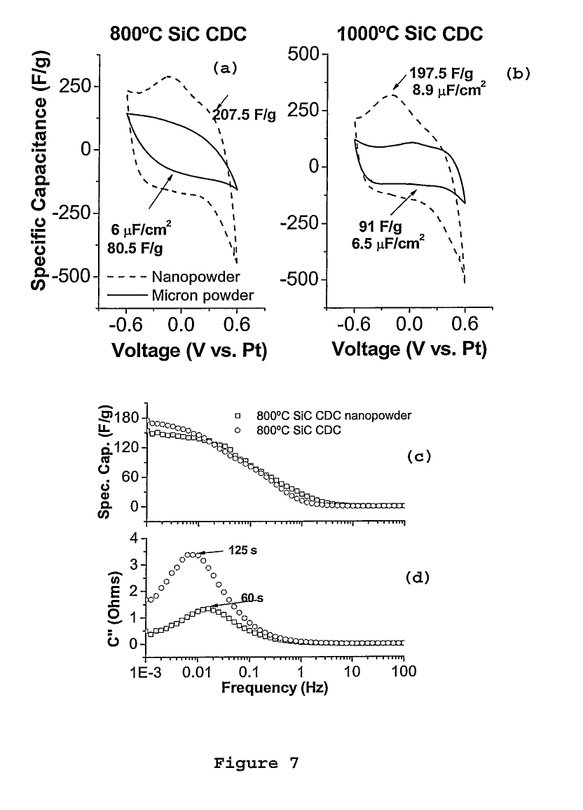

### DETAILED DESCRIPTION OF THE INVENTION

The present invention relates to nanocellular high surface area materials comprising carbon materials with a high surface area that is controllable. The nanocellular high surface area materials also exhibit high conductivity as well as a precisely controllable pore size. These nanocellular high surface area materials are preferably nanocellular carbons. By nanocellular carbons it is meant a disordered porous material consisting mainly of carbon (>90 at. % carbon) and having cells (pores) formed between non-planar graphene fragments.

For purposes of the present invention, by high surface area it is meant the surface area is above 800 m²/g.

By high conductivity it is meant the conductivity is greater than 1-10 S/cm⁻¹.

Pore sizes range preferably from about 0.5 nm to about 3 nm.

The present invention also relates to a method for producing these nanocellular high surface area materials.

In one embodiment of this method, the starting material is an inorganic carbon-containing precursor comprising a compound based on a metal, metalloid or a combination thereof from the group Ti, Zr, Hf, V, Ta, Nb, Mo, W, Fe, Al, Si, B, Ca, Cr. Preferably the starting material is a carbide, a mixture of carbides, a carbonitride, a mixture of carbonitrides or a mixture of carbides and carbonitrides, more preferably a metal carbide. Examples include, but are not limited to, SiC, TiC, B₄C, WC, MoC, VC, NbC, TaC, Cr₃C₂, CaC₂, ZrC, Al₄C₃, SrC₂, V₂C, W₂C, Mo₂C, BaC₂, Ta₂C, Nb₂C, Cr₄C, ternary carbides and others. Inorganic carbon-containing precursors include, but are not limited to, binary and ternary carbides and mixtures thereof. The structure of the inorganic carbide-containing precursor may be amorphous, nanocrystalline, microcrystalline, or crystalline. In this embodiment, the particle size of the inorganic carbide-containing precursor typically ranges from about 1 to about 100 microns, preferably about 1 to about 20 microns. In some embodiments particle size may range from about 400 to about 1,000 nanometers.

It has now been found that removal of the non-carbon atoms from an inorganic carbide-containing precursor such as a metal carbide starting material at elevated temperatures in a halogen environment results in a carbon material with a high surface area that is controllable by choice of starting carbide and synthesis temperature and which exhibits high conductivity and a precisely controllable pore size, pore shape and microstructure.

In another embodiment of this method, nanocellular high surface area materials are synthesized from nano-sized inorganic precursor particles. The inventors have now found that use of small (<400 nm) sized precursor particles decreases the overall time and temperature needed for the production of nanocellular high surface area carbon-containing material. For this embodiment, it is preferred that the nano-sized inorganic precursor particles range in size from about 10 nm to about 4500 nanometers. In addition, nanoparticles of the synthesized nanocellular high surface area materials allow faster diffusion of species in and out of these particles, which could be advantageous for many applications (e.g. as electrodes in electrochemical energy storage systems such as electrical double layer capacitors, EDLC). Furthermore, when nanocellular high surface area materials are synthesized from nano-sized inorganic precursor particles, their physical properties (e.g. pore volume, surface area, and microstructure) can be different as compared to that of the nanocellular high surface area materials synthesized from the regular (1-100 micron) sized particles. These different properties allow for superior performance when used in electrochemical energy storage system (e.g. as electrodes in EDLC). Furthermore, combining different size particles of nanocellular high surface area materials in a compacted state may decrease the space between the particles, thus improving the volumetric performance of the material in the desired application, for example when used in electrochemical energy storage system such as EDLC.

The present invention also relates to a method of improving the performance of nanocellular high surface area materials discussed above by annealing them at elevated temperatures in hydrogen containing atmosphere. In a preferred embodiment, annealing is in-situ, without exposure of the samples to air or oxygen containing atmosphere.

For purposes of the present invention, by elevated temperature it is meant in the range of about 200-1200° C. The preferred synthesis temperature will vary depending upon the metal carbide starting material. For example, for Ti₂AlC and B₄C the preferred elevated temperature for synthesis is 1000° C. For metal carbides such as TiC and ZrC, the preferred elevated temperature is 800° C.

By halogen environment it is meant an environment that, for purposes of the present invention comprises a halogen alone, preferably chlorine, or a mixture of halogen and other gases, preferably inert gases. Other halogens such as iodine, bromine or fluorine can also be used but may impart different characteristics to the carbon material.

The ability of the method of the present invention to produce carbon materials with a high surface area that is controllable and which exhibits high conductivity and a precisely controllable pore size was demonstrated with the exemplary metal carbides Ti₂AlC and B₄C.

In these experiments, nanoporous carbons obtained by selective leaching of Ti and Al from Ti₂AlC, as well as B from B₄C, were investigated as electrode materials in electric double-layer capacitors (EDLCs). Cyclic voltammetry (CV) tests were conducted in 1M H₂SO₄ from 0-250 mV on carbons synthesized at 600° C., 800° C., 1000° C., and 1200° C. Results show that the structure and pore sizes can be tailored and that the optimal synthesis temperature is 1000° C. Specific capacitance for Ti₂AlC CDC and B₄C CDC were 175 F/g and 147 F/g, respectively, compared to activated carbon and multi wall carbon nanotubes, which were calculated to be 52 F/g and 15 F/g, respectively.

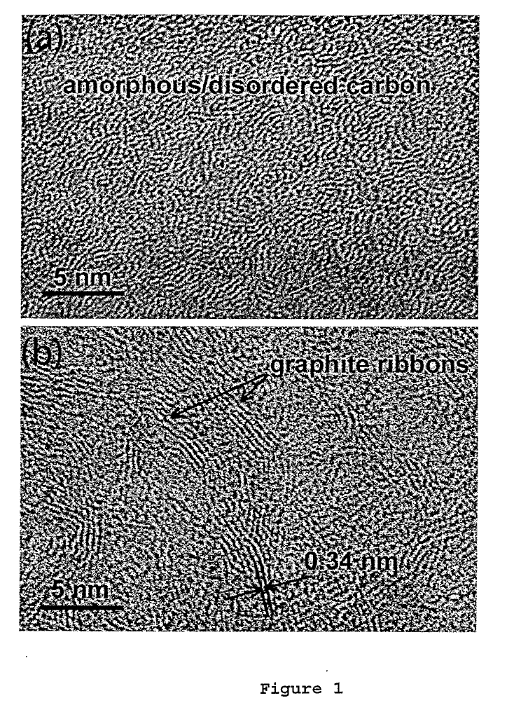

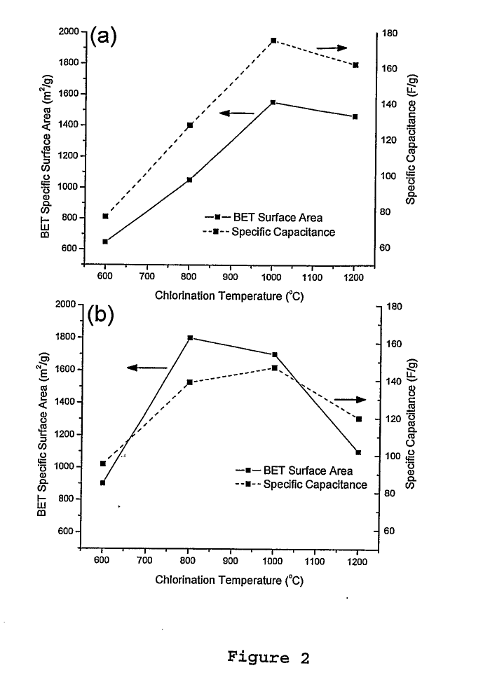

More specifically, it was found that CDCs synthesized at low temperatures are amorphous. Higher temperature synthesis generally resulted in the formation of graphitic structures. FIG. 1(a) shows a transmission electron microscopy (TEM) micrograph of CDC produced from Ti₂AlC at 400° C. The highly disordered structure of the material was clearly visible. Ti₂AlC synthesized at 1200° C. (FIG. 1(b)) demonstrated a network of graphitic ribbons mixed in with a more disordered carbon structure. The structure of B₄C CDC synthesized in this temperature range is similar (Dash et al. Microporous and Mesoporous Materials 2004 72:203). The low graphitization temperature of CDC resulted in more graphitic structure than activated carbon, without a compromise in specific surface area (FIG. 2).

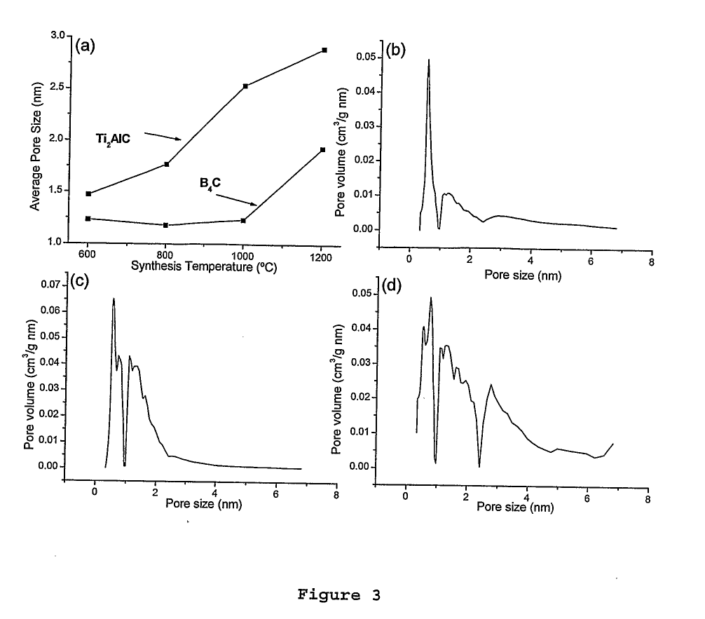

Pore sizes for Ti₂AlC CDCs and B₄C CDCs calculated by using a weighted pore density functional theory (DFT) showed that the average pore diameter increases with synthesis temperature (FIG. 3(a)). Though the distribution figures (FIG. 3(b)-(d)) show multi-modal pore size distributions with minimas of zero, this is an artifact of the DFT model. The actual pore size distribution, though possibly multimodal, was a more uniform distribution of the pore sizes. The activated carbon PSD (FIG. 3(b)) exhibits mainly small micropores with a mean diameter of approximately 0.5 nm and a very small tail region of larger micropores. FIGS. 3(c) and 3(d) are representative of the changes in pore structure of CDC with synthesis temperature. They show B₄C-derived CDC at 600° C. and 1200° C. synthesis temperatures, respectively. At 600° C. the total pore volume is comprised largely by microporosity, whereas at 1200° C. the pore size distribution widens and shifts to larger average pore diameters. This is a feature that is seen in the synthesis of a majority of CDCs.

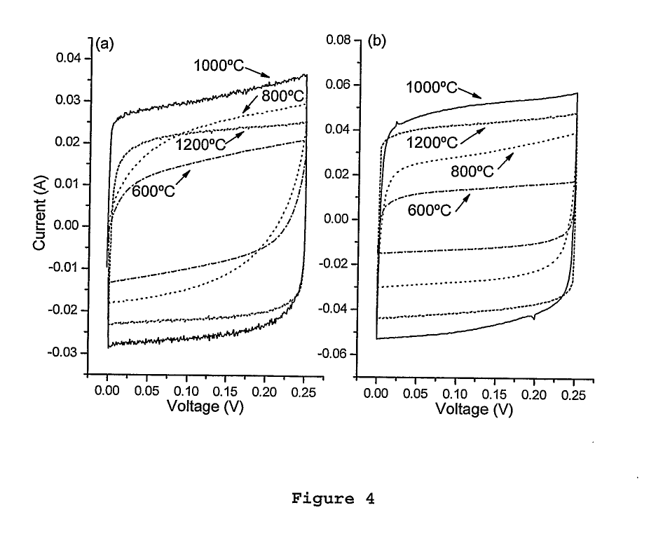

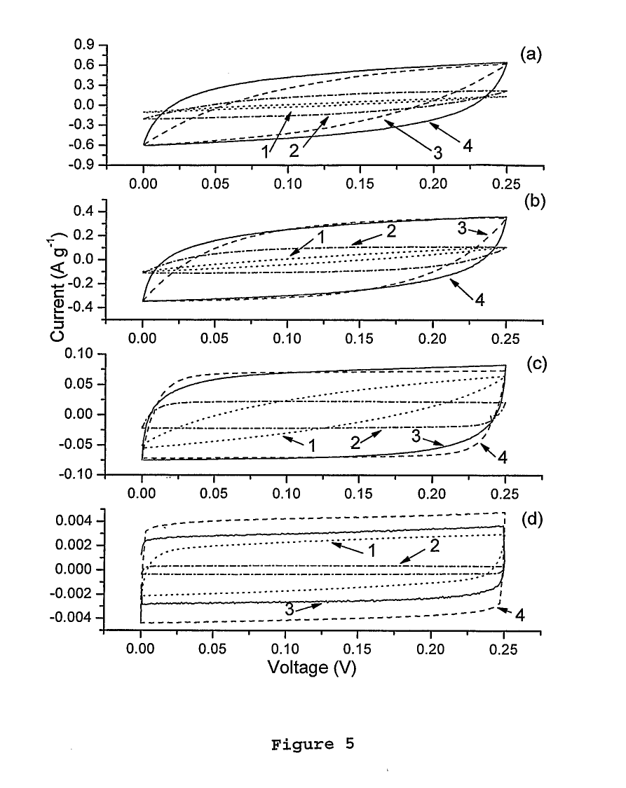

Large SSAs could be obtained for CDCs without further activation of the carbon product (FIG. 2). In Ti₂AlC CDCs, the SSAs calculated from N₂ adsorption increased from approximately 800 m²/g at 600° C. to a maximum of approximately 1550 m²/g at 1000° C. (FIG. 2(a)). The SSA then decreased as the chlorination temperature increased due to increasing graphitization and closing off of small pores of the amorphous carbon. B₄C CDC has a maximum SSA of approximately 1800 m²/g at 800° C. (FIG. 2(b)). The SSAs of both CDCs were dominated by pores accessible to the aqueous electrolyte ions. The SSAs of commercially available activated carbon and carbon nanotubes were 547 m²/g and 180 m²/g, respectively, both significantly lower than the CDCs reported here. CV tests were conducted to characterize electrochemical performance. No faradic reactions were found within the voltage window of interest for either material (FIGS. 4 and 5). B₄C CDC synthesized at 600° C. gave 95 F/g, increasing to 147 F/g for 1000° C. synthesis (FIGS. 4a & 2b). This temperature, 1000° C. is believed to be the optimum synthesis temperature for B₄C CDC and Ti₂AlC CDC; at 1200° C. the value dropped to 120 F/g. This trend follows that of the BET SSA. By BET SSA it is meant the specific surface area obtained by analyzing gas (generally Ar or N₂) sorption isotherm using a BET equation (see P. I. Ravikovitch and A. V. Neimark, Characterization of Nanoporous Materials from Adsorption and Desorption Isotherms. Colloids and Surfaces, 2001. 187-188: p. 11-21; S. J. Gregg and K. S. W. Sing, “Adsorption, Surface Area and Porosity”, London: Academic Press, UK 1982, 42; S. Brunauer, P. Emmett, and E. Teller, J. of Am. Chem. Soc., 1938, 60, 309; S. Lowell and J. E. Schields, “Powder Surface Area and Porosity”, Chapman & Hall, New York, US 1998, 17). The observed small deviations are believed to be connected to the incomplete accessibility of the smallest pores to the electrolyte ions. Ti₂AlC CDC's followed even closer the correlation between capacitance and SSA (FIG. 4(b) and FIG. 2(a)): synthesis at 600° C. resulted in specific capacitance of 77 F/g, while at 1000° C. it was 175 F/g, the highest of all materials tested. For comparison, activated carbon and carbon nanotubes yielded only 52 F/g and 15 F/g, respectively. These low values again correlate with the low SSAs of these materials, 547 m²/g and 180 m²/g, respectively.

When normalized by their SSAs, CDC capacitors still had higher specific capacitance than the multi walled carbon nanotubes (MWNTs) tested: 8.7 μF/cm² for B₄C CDC synthesized at 1000° C., 11.3 μF/cm² for Ti₂AlC CDC synthesized at 1000° C., 8 μF/cm² for MWNTs and 9.5 μF/cm² for activated carbon. Localized oxygen containing functional groups generated during the carbon activation contribute to higher surface reactivity and may explain the larger specific capacitance compared to B₄C CDC (Conway, B. E. Electrochemical Capacitors; Scientific Fundamentals and Technological Applications, Luwer (1999)). The influence of oxygen-containing functional groups in activated carbon is not enough to generate specific capacitances greater than the highly developed porous structure in Ti₂AlC, however.

CV tests from 5 mV/sec to 50 mV/sec and 0<V<250 mV were performed to gain a qualitative understanding of the influence of pore structure on the rate dependence of the charge-discharge behavior. Deviations from ideal behavior are found at the highest scan rates (FIG. 5), where the current response is slower in more microporous electrodes. Ti₂AlC CDC and B₄C CDC synthesized at 1000° C. have the largest fraction of mesopores (>2 nm diameter) and show only small deviations from ideal behavior at 50 mV/s (FIG. 5(c,e)). Activated carbon has the smallest pores and shows the poorest high-rate performance. The behavior of Ti₂AlC CDC and B₄C CDC at 1000° C. show that by controlling the pore size, both the high rate performance and the specific capacitance of the EDLC cells could be controlled. Further optimization of the porous structure of CDC should yield even better specific capacitance and lower rate constants.

Thus, as demonstrated by these experiments, porous carbon electrodes can be produced by selective leaching of metals from a metal carbide in a halogen environment at elevated temperatures. The resulting CDC electrodes produced in accordance with this method exhibit specific capacitances dependent on pore size and SSA and structure, all of which are precisely controllable by the synthesis temperature and choice of starting carbide. In fact, these nanocellular high surface area materials produced in accordance with this method exhibit specific capacitances comparable to the best carbon materials reported in literature for use in EDLCs. Thus the characteristics of the carbon materials are indicative of their utility in multiple electrochemical application including, but in no way limited to lithium-ion hybrid battery electrodes, supercapacitor electrodes and fuel cell electrodes.

Further, the demonstrated ability to control the porous structure of the carbon electrodes using methodologies of the present invention, provides for further tuning of the CDC structure expected to result in even higher specific capacitance.

The following nonlimiting examples are provided to further illustrate the present invention.

### EXAMPLES

B₄C powder (Alfa Asear, Ward Hill, Mass.) of 2.53 g/cm³ density, 99.4% purity and 6 μm average particle size was chlorinated at 600° C., 800° C., 1000° C., and 1200° C. Bulk Ti₂AlC pieces, (3-ONE-2, Voorhees, N.J.) were chlorinated at temperatures of 600° C., 800° C. and 1000° C. These samples were crushed in a mortar (to an average particle size of approximately 12 μm) after chlorination to produce powder. SiC powder with an average particle size of either approximately 30 nm or approximately 800 nm (0.8 μm) was chlorinated at temperatures of 800 and 1000° C. ZrC powder with an average particle size of approximately 8 μm was chlorinated in the 200-1200° C. temperature range. Chlorination was performed in accordance with the technique reported by Nikitin, A. and Gogotsi, Y. (Nanostructured Carbide Derived Carbon (CDC), Encyclopedia of Nanoscience and Nanotechnology, H. S. Nalwa, American Scientific Publishers 7 553 (2003)) and Dash et al. (Microporous and Mesoporous Materials 2004 72:203).

Porosity analysis was carried out at −195.8° C. using a Quantachrome Autosorb-1 and N₂ and Ar as the adsorbates. Pore size distributions were calculated from Ar adsorption data using the density functional theory (DFT) method (Seaton et al. Carbon 1989 27(6):853) provided by Quantachrome data reduction software version 1.27 and the SSA was calculated using the Brunauer, Emmet, Teller (BET) method (Journal of American Chemical Society 1938 60(2):309).

The powders were processed into capacitor electrodes by mixing them with 5 wt % Teflon® (E.I. du Pont de Nemours, Wilmington, Del.) powder, homogenized in a mortar and pestle and finally rolled into a thin film of uniform thickness (˜175 μm). Probe conductivity measurements showed the resistivity of the CDC to be on the order of 1 Ω-cm, which was low enough to eliminate the need for carbon black additions. From this film, 1 cm² circular electrodes were punched out and inserted into a two electrode test cell with a porous polypropylene separator (Celgard Inc., Charlotte, N.C.) and a 1 M H₂SO₄ aqueous electrolyte. Electrode films were also prepared from activated carbon (Alfa Asear, Ward Hill, Mass.) and multi-wall carbon nanotubes (Arkema, Serquigny, France) for comparison. CV experiments were conducted between 0 mV and 250 mV using a Princeton Applied Research 273 potentiostat/galvanostat. The specific capacitances were calculated from data taken at a scan rate of 1 mV/s.

1. A nanocellular high surface area material comprising a carbon material with high surface area that is controllable and which exhibits high conductivity and a precisely controllable pore size and structure.

2. A method for synthesis of a nanocellular high surface area carbon material with controllable porosity, structure and conductivity from inorganic carbon-containing precursor comprising removing a majority of non-carbon atoms from the inorganic carbon-containing precursor.

3. The method of claim 2 wherein the inorganic carbon-containing precursor comprises a compound based on a metal, metalloid or combination thereof selected from the group consisting of Ti, Zr, Hf, V, Ta, Nb, Mo, W, Fe, Al, Si, B, Ca and Cr.

4. The method of claim 2, where the inorganic carbon-containing precursor comprises a carbide, a mixture of carbides, a carbonitride, a mixture of carbonitrides or a mixture of carbides and carbonitrides.

5. The method of claim 2 wherein the inorganic carbide-containing precursor is amorphous, nanocrystalline, microcrystalline, or crystalline in structure.

6. The method of any claim 2 wherein the nanocellular high surface area carbon-containing material is synthesized from the inorganic carbon-containing precursor by thermo-chemical, chemical or thermal treatment of the inorganic carbon-containing precursor in a temperature range of 200-1200° C.

7. The method of claim 2 wherein the nanocellular high surface area carbon-containing material is synthesized from the inorganic carbon-containing material by reacting the inorganic carbon-containing precursor with a halogen containing gas or gas mixture in the temperature range of 200-1200° C.

8. The method of claim 7 wherein the halogen containing gas or gas mixture comprises chlorine.

9. The method of claim 7 further comprising treatment in a hydrogen containing gas or gas mixture at an elevated temperature.

10. The method of claim 2 wherein the inorganic carbon-containing precursor comprises particles with an average diameter ranging between 10 to 20,000 nanometers.

11. The method of claim 10 wherein the inorganic carbon-containing precursor comprises particles with an average diameter ranging between 1,000 to 20,000 nanometers.

12. The method of claim 10 wherein the inorganic carbon-containing precursor comprises particles with an average diameter ranging between 400 to 1,000 nanometers.

13. The method of claim 10 wherein the inorganic carbon-containing precursor comprises particles with an average diameter ranging between 10 to 400 nanometers.

14-15. (canceled)

16. A nanocellular high surface area carbon-containing material made according to the process of claim 2.

17. An electrode comprising the nanocellular high surface area carbon-containing material of claim 16.

18. An electrochemical energy storage device comprising the electrode of claim 17.

19. An electrical double layer capacitor comprising the electrode of claim 17.
